(19) United States
(12) Patent Application Publication
(10) Pub. No.: US 2016/0214123 A1
(43) Pub. Date: Jul. 28, 2016

(54) SPRINKLING HEAD OF A PERCUSSIVE SPRINKLER

(71) Applicant: Cheng-An WANG, Chang Hua Hsien (TW)

(72) Inventor: Cheng-An WANG, Chang Hua Hsien (TW)

(21) Appl. No.: 14/605,386

(22) Filed: Jan. 26, 2015

(51) Int. Cl. B05B 3/02; B05B 1/14; B05B 15/06; B05B 3/04

(52) U.S. Cl. CPC B05B 3/021; B05B 3/0409; B05B 1/14; B05B 15/065

(57) ABSTRACT

A sprinkling head of a percussive sprinkler includes a connecting portion and a protrusion vertically extending from one end of the connecting portion to form an L-shaped structure, wherein the connecting portion is adapted to be mounted onto the percussive sprinkler The connecting portion includes a recess defined in a bottom thereof and communicating with a passage in the percussive sprinkler, and an outlet defined in a top thereof and communicating with the recess such that the outlet communicates with the passage via the recess. A tunnel is defined in the protrusion and communicates with the recess and a series of spraying holes are defined in a bottom of the tunnel for forming an annular irrigating area.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to sprinkling head, and more particularly to a sprinkling head of a percussive sprinkler

2. Description of Related Art Including Information Disclosed Under 37 CFR 1.97 and 37 CFR 1.98.

Percussive sprinklers are extensively used for gardening and spraying, since circulating or reciprocating water sprinkling of the percussive sprinklers can be realized in an annular zone. In order to further improve its practicability, a tilting percussive sprinkler has been developed, allowing to adjust the outlet angle by tilting upwards or downwards so as to meet the user's diversified demands.

A conventional percussive sprinkler generally comprises a main body, a tubing portion located at a bottom of the main body, a percussive frame rotatably mounted on the main body and a steering structure disposed on the main body. To achieve the purpose above, the conventional percussive sprinkler needs to contain a tilting structure disposed between the tubing portion and the main body.

As a result, the cost of the percussive sprinkler must be raised. In addition, the percussive frame reciprocally impinges the main body for changing the spray direction of the percussive sprinkler when being operated to spray water. However, the reciprocally rotated percussive frame will block the water column from the main body such that the irrigating water column is choppy and the main must be rotated for several circles for providing a complete irrigating area. As a result, some water is wasted and the wet degree is not average in the irrigating area.

The present invention has arisen to mitigate and/or obviate the disadvantages of the conventional percussive sprinkler

### BRIEF SUMMARY OF THE INVENTION

The main objective of the present invention is to provide an improved sprinkling head that includes a series of spraying holes defined therein for forming an annular irrigated area.

To achieve the objective, the sprinkling head of a percussive sprinkler in accordance with the present invention comprises a connecting portion and a protrusion vertically extending from one end of the connecting portion to form an L-shaped structure, wherein the connecting portion is adapted to be mounted onto the percussive sprinkler The connecting portion includes a recess defined in a bottom thereof and communicating with a passage in the percussive sprinkler, and an outlet defined in a top thereof and communicating with the recess such that the outlet communicates with the passage via the recess. A tunnel is defined in the protrusion and communicates with the recess and a series of spraying holes are defined in a bottom of the tunnel for forming an annular irrigating area.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a perspective view for showing the sprinkling head in accordance with the present invention and a percussive sprinkler

FIG. 2 is a top cross-sectional view of the sprinkling head in accordance with the present invention.

FIG. 3 is a perspective view of the sprinkling head in accordance with the present invention.

FIG. 4 is another perspective view of the sprinkling head in accordance with the present invention.

FIG. 5 is a cross-sectional view of the sprinkling head in FIG. 3.

FIG. 6 is a cross-sectional view of a second embodiment of the sprinkling head in accordance with the present invention.

### DETAILED DESCRIPTION OF THE INVENTION

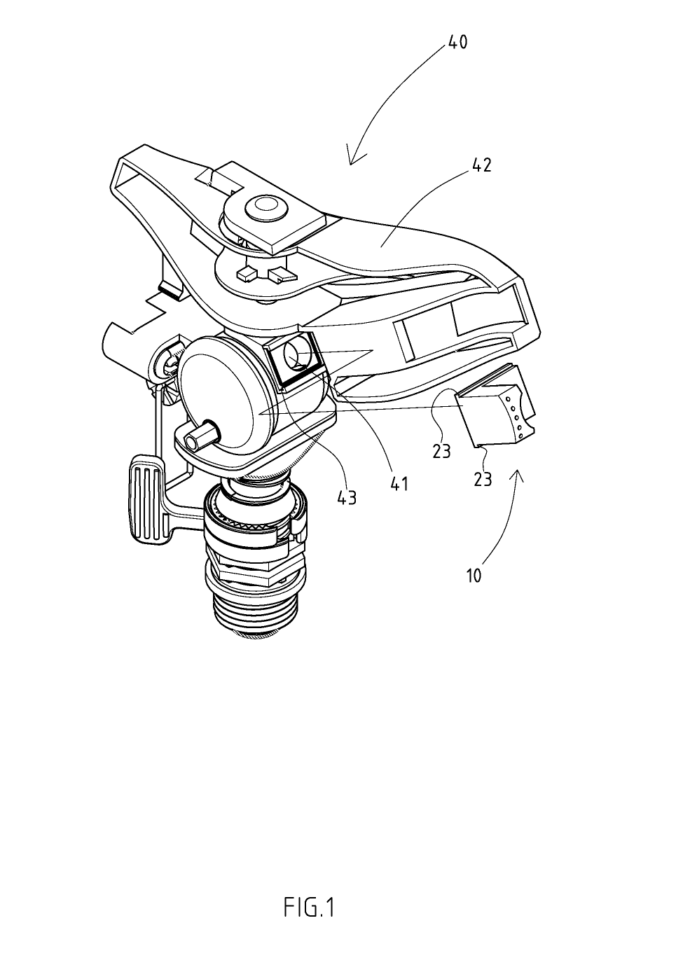

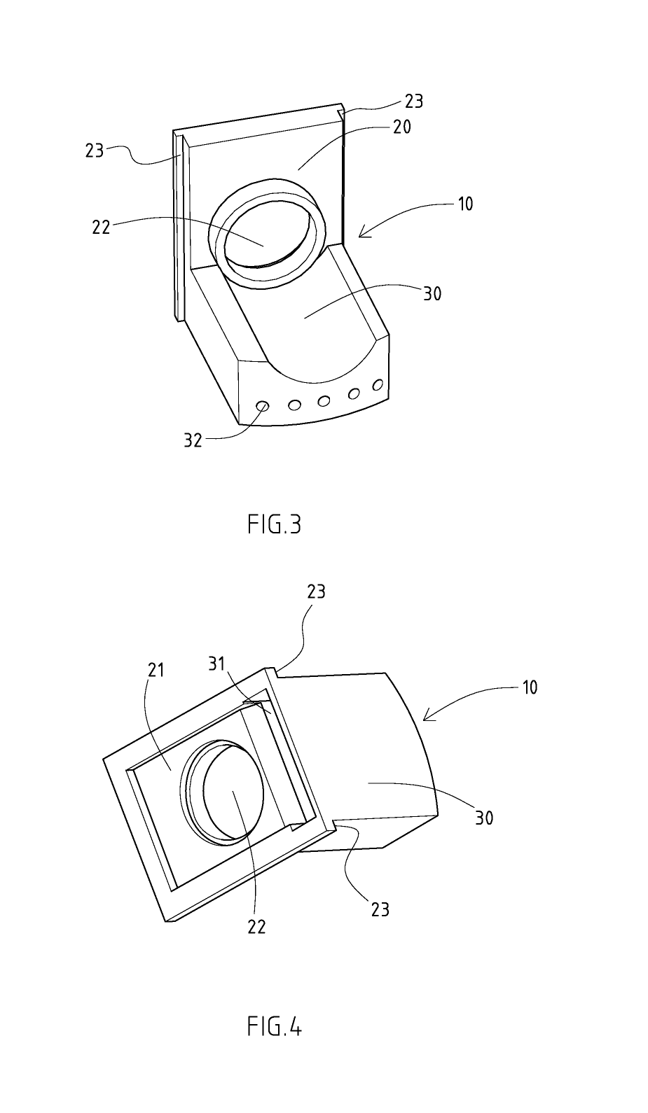

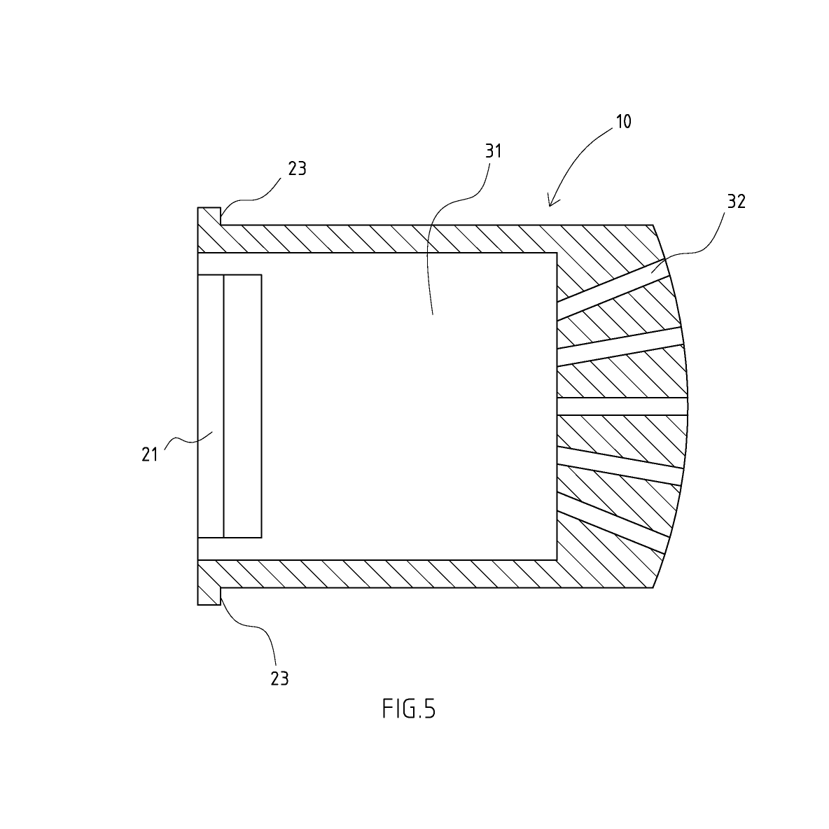

Referring to the drawings and initially to FIGS. 1-4, a percussive sprinkler 40 includes a passage 41 defined therein and a percussive frame 42 pivotally mounted thereon, wherein the percussive frame 42 is reciprocally swung relative to the percussive sprinkler 40 during sprinkling water and the passage 41 allows water sprayed out of the percussive sprinkler 40. The sprinkling head 10 in accordance with the present invention comprises a connecting portion 20 and a protrusion 30 vertically extending from one end of the connecting portion 20 to form an L-shaped structure, wherein the connecting portion 20 is adapted to be mounted onto the percussive sprinkler 40. In the preferred embodiment of the present invention, the percussive sprinkler 40 includes two parallel grooves 43 peripherally defined thereon and the connecting portion 20 includes two opposite sides each having a rail 23 laterally extending therefrom, wherein each rail 23 is slidably received in a corresponding one of the two grooves 43 for slidably mounting the sprinkling head 10 in accordance with the present invention on the percussive sprinkler 10. Consequently, the sprinkling head 10 in accordance with the present invention is changeable top the percussive sprinkler 10. However, for providing a better strength between the sprinkling head 10 and the percussive sprinkler 40, the sprinkling head 10 in accordance with the present invention also can be secured on the percussive sprinkler 10 by hot-melted or high frequency weld.

The connecting portion 20 includes a recess 21 defined in a bottom thereof and communicating with the passage 41 in the percussive sprinkler 40, and an outlet 22 defined in a top thereof and communicating with the recess 21 such that the outlet communicates with the passage 41 via the recess 21. A tunnel 31 is defined in the protrusion 30 and communicates with the recess 21. A series of spraying holes 32 is radially defined in a bottom of the tunnel 31 such that each spraying hole 32 has an elevation different from one another for forming multiple slim water columns with different spray distances.

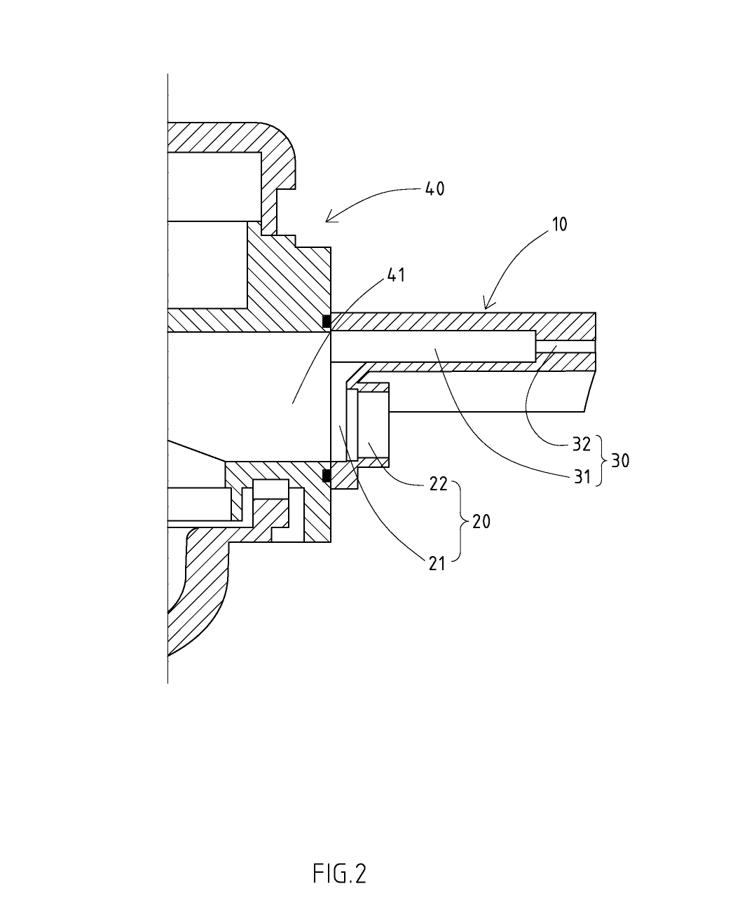

With reference to FIGS. 2, 3, 4 and 5, when operating the percussive sprinkler 40 with the sprinkling head 10 in accordance with the present invention, the water current flows through the passage 41 in the percussive sprinkler 40 into the sprinkling head 10, wherein most water in the sprinkling head 10 flows through the outlet 22 for spraying and driving the percussive frame 42 to changing the spraying direction of the percussive sprinkler 40, and some water is sprayed by the spraying holes 32 after sequentially passing through the recess 21 and the runnel 31. The slim water column from each of the spraying holes 32 is continual and does not intermittently blocked by the operating percussive frame 42 such that the slim water column from the spraying holes 32 can forms a annular irrigating area for widening the coverage area of the percussive sprinkler 40 after being combined with the irrigating area formed by the outlet 22.

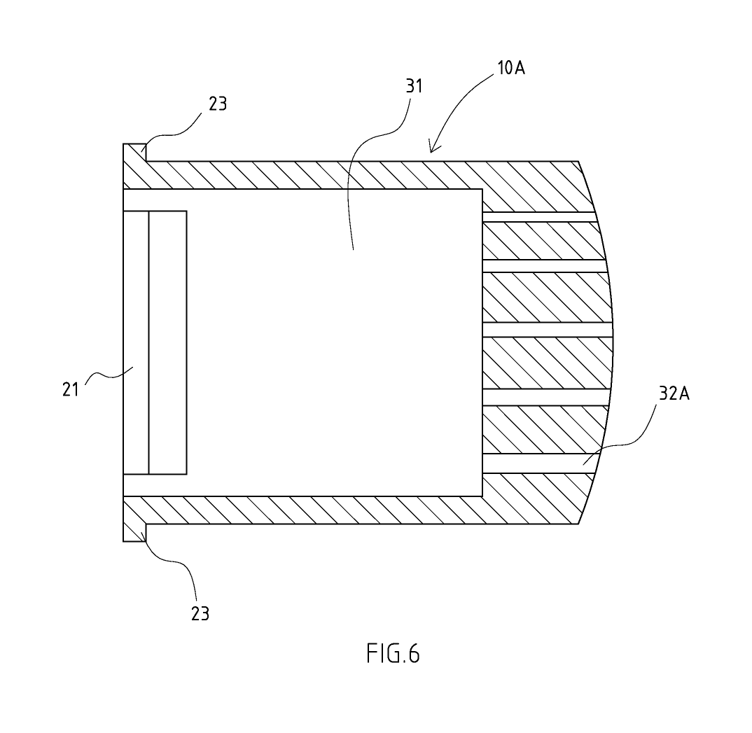

With reference to FIG. 6 that shows second embodiment of the sprinkling head 10A in accordance with the present invention, in this embodiment, the series of spraying holes 32A in the bottom of the tunnel 31 are parallel relative to one another, wherein the diameters of each of the spraying holes 32A are gradually reduced according to the height of each of the spraying holes 32A for achieving the effect as the first embodiment, hereinbefore.

Although the invention has been explained in relation to its preferred embodiment, it is to be understood that many other possible modifications and variations can be made without departing from the spirit and scope of the invention as hereinafter claimed.

1. (canceled)

2. (canceled)

3. (canceled)

4. (canceled)

5. (canceled)

6. (canceled)

7. (canceled)

8. (canceled)

9. (canceled)

10. A sprinkler head for a percussive sprinkler, the sprinkler head comprising:
a body having a connecting portion and a protrusion in an L-shaped configuration in which said protrusion extends outwardly in transverse relation to a plane of said connecting portion, said connecting portion adapted to be mounted onto the percussive sprinkler, said connection portion having a recess at one end thereof, said recess adapted to communicate with a passage of the percussive sprinkler, said connecting portion having an outlet communicating with said recess such that said outlet is adapted to communicate with the passage via said recess, said outlet having an end opposite said recess so as to allow water to be projected therefrom, said protrusion having a tunnel therein, said tunnel communicating with said recess, said protrusion having a series of spraying holes at an end of said tunnel opposite said recess, said in end said tunnel extending substantially outwardly beyond said end of said outlet, said outlet having an inner diameter substantially greater than an inner diameter of said tunnel.

11. The sprinkler head of claim 10, wherein each of said plurality of spraying holes has an elevation different of one another.

12. The sprinkler head of claim 10, said plurality of spraying holes having a diameter reducing relative to a height of said spraying holes.

13. The sprinkler head of claim 10, said connecting portion having opposite sides each having a rail laterally extending therefrom, said rail adapted to be slidably received in a corresponding groove on the percussive sprinkler.

14. The sprinkler head of claim 11, said connecting portion having opposite sides each having a rail laterally extending therefrom, said rail adapted to be slidably received in a corresponding groove on the percussive sprinkler.

15. The sprinkler head of claim 12, said connecting portion having opposite sides each having a rail laterally extending therefrom, said rail adapted to be slidably received in a corresponding groove on the percussive sprinkler.

16. The sprinkler head of claim 10, said connecting portion adapted to be hot-melted adhesively simply secured to the percussive sprinkler.

17. The sprinkler head of claim 11, said connecting portion adapted to be hot-melted adhesively simply secured to the percussive sprinkler.

18. The sprinkler head of claim 12, said connecting portion adapted to be hot-melted adhesively secured to the percussive sprinkler.
